(19) United States
(12) Patent Application Publication
(10) Pub. No.: US 2008/0293853 A1
(43) Pub. Date: Nov. 27, 2008

(54) METHOD FOR PRODUCING CARBON NANOTUBE/POLYMER MIXTURES BY GAS-PHASE POLYMERIZATION

(75) Inventors: AUREL WOLF, WULFRATH (DE); SIGURD BUCHHOLZ, KOLN (DE); VOLKER MICHELE, KOLN (DE); LESLAW MLECZKO, DORMAGEN (DE); REINER RUDOLF, LEVERKUSEN (DE)

Correspondence Address: NORRIS, MCLAUGHLIN & MARCUS, PA, 875 THIRD AVENUE, 18TH FLOOR, NEW YORK, NY, 10022, US

(73) Assignee: BAYER MATERIALSCIENCE AG, Leverkusen (DE)

(21) Appl. No.: 11/830,133

(22) Filed: Jul. 30, 2007

(30) Foreign Application Priority Data
Aug. 1, 2006 (DE) 102006035773.6

(51) Int. Cl. C08K 5/00

(52) U.S. Cl. 524/81; 524/855

(57) ABSTRACT

The present invention relates to a novel method for producing polymer/carbon nanotube mixtures by gas-phase polymerization, optionally subsequent dispersion in a carbon nanotube/polymer composite, and in particular homogeneous carbon nanotube/polymer mixtures and carbon nanotube/polymer composites by in situ gas-phase polymerization of olefins or diolefins on carbon nanotubes, wherein the catalysts and, optionally, co-catalysts are supported on the carbon nanotubes.

The present invention relates to a novel method for producing polymer/carbon nanotube mixtures by gas-phase polymerization.

Within the scope of the present invention, carbon nanotubes (CNTs) are understood as being generally cylindrical carbon tubes having a diameter of from 3 to 150 nm, preferably from 3 to 80 nm, the length being a multiple of at least 100 times the diameter. These tubes consist of layers of ordered carbon atoms and have a core that differs in terms of morphology. Such carbon nanotubes are also referred to in the literature as, for example, “carbon fibrils” or “hollow carbon fibers”. Owing to their dimensions and their particular properties, the described carbon nanotubes are important industrially for the production of composite materials. Further important possibilities are applications in electronics, energy and other fields.

Application-related properties of polymers can be markedly improved by the incorporation of nano-fillers. According to Walter et al., Macromol. Sci., 1999, A 36, 1613, improvements in properties can be achieved even with very low nano-filler contents. Such nano-filler/polymer mixtures can be produced, for example, by melt introduction, introduction by means of a polymer dissolution procedure or by means of in situ polymerization. The latter method has the advantage that no additional operation to produce the filler/polymer mixture is necessary after the polymerization.

The production of carbon nanotube/polyolefin mixtures or of carbon nanotube/diolefin-based polymer mixtures is known from scientific and technical literature.

Wiemann et al., Conference, IUPAC-Symposium Macro, 2004, Paris, and Bonduel et al., Chem. Comm., 2005, 781-783 describe the production of carbon nanotube/polypropylene mixtures by means of in situ polymerization in the presence of carbon nanotubes. The polymerization is a solution polymerization, i.e. the polymerization is carried out in a solvent, wherein catalyst (Zr-metallocene) and promoter (MAO) have been dissolved. This method has the disadvantage that energy-intensive removal of the solvent is necessary.

WO 99/23287 A1 and WO 01/10779 A1 claim the production of rigid, interpenetrating networks of carbon nanotubes and polymers by in situ polymerization. The in situ polymerization described therein can be catalyzed, or started, by Ziegler-Natta catalysts, by metallocenes and also by free-radical initiators. For example, the polymerization of ethylene is carried out on TiCl₄/MAO catalysts supported on carbon nanotubes, while propylene polymerization takes place on a zirconocene/MAO catalyst supported on carbon nanotubes. While the first example represents a conventional gas-phase polymerization, in the second example the propylene is condensed or frozen, and a “true” solution polymerization subsequently begins by thawing. These processes have the disadvantage that they do not yield homogeneous mixtures of carbon nanotubes and polymer but merely rigid, only partially interpenetrating networks of polymer and carbon nanotubes. More precisely, the polymerization takes place mainly at the surface of the carbon nanotube agglomerates, and dispersion of the carbon nanotubes within the polymer matrix as the polymerization progresses does not occur. This manifests itself in the described grey or white color of the carbon nanotube/polymer mixtures. The unsuitable application of the catalysts to the carbon nanotubes might be regarded as a cause. The outer surfaces of the carbon nanotube particles are loaded with catalyst by impregnation, at the same time the catalyst is bonded to the carbon nanotubes only by loose physical forces. As a result, the production of homogeneous mixtures of polymer/carbon nanotubes is not possible. Only the claimed rigid, “interpenetrating” networks are obtained.

WO 95/07316 A1 describes the production of carbon nanotube/rubber mixtures by compounding. These mixtures exhibit inhomogeneous distribution of the carbon nanotubes in the polymer, so that “undissolved” carbon nanotube bundles of >1 μm are still found.

The few examples hitherto known in the scientific and technical literature for the production of homogeneous carbon nanotube/polyolefin mixtures or carbon nanotube/rubber mixtures are distinguished by poor quality of the mixtures, or the methods cannot be transferred to large-scale production.

An object of the present invention was to provide a method which allows carbon nanotube/polyolefin mixtures or carbon nanotube/rubber mixtures to be produced by means of in situ gas-phase polymerization. In particular, a widely applicable method is to be found which ensures that homogeneous mixtures of carbon nanotubes and polymer are formed and which also avoids potentially problematic or technically complex ways of carrying out the reaction and working up. At the same time, the method is to bring advantages in respect of the space/time yield, handling, economy and ecology on an industrial scale.

Surprisingly, it has now been found that homogeneous carbon nanotube/polymer mixtures or carbon nanotube/rubber mixtures can be produced by gas-phase polymerization by means of carbon nanotube-supported catalysts.

The present invention accordingly provides a method for producing homogeneous carbon nanotube/polymer mixtures or carbon nanotube/rubber mixtures by in situ gas-phase polymerization of olefins or diolefins on carbon nanotube-supported polymerization catalysts.

The carbon nanotubes used in the method according to the present invention as catalyst support or as filler can be produced inter alia by decomposition of carbon-containing gaseous compounds from the gas phase on metal-containing catalysts. Examples of suitable carbon components include, without implying any limitation: methane, ethane, propane, butane, isobutane, ethylene, propylene, butene, butadiene and acetylene. As catalytic metal components there are a number of suitable transition metals such as, for example, nickel, iron, molybdenum, cobalt, manganese, copper, chromium, vanadium, tungsten, and the binary, tertiary, quaternary, etc. mixtures thereof, as described, for example, in WO 2006050903 A2.

Carbon nanotube-supported catalysts (CNT catalysts) are conventionally produced by adding the catalyst in solution in a dry solvent, for example, toluene, benzene, heptane, hexane, or cyclohexane, to the carbon nanotube suspension and fixing the catalyst to the carbon nanotube surface. Production of the supported CNT catalyst is then completed by separating off the solvent, for example, by evaporation.

In a particular form of the method according to the present invention, the carbon nanotubes are treated physically or chemically. In particular, the carbon nanotubes are usually either “washed” or “functionalized” by means of physical or chemical treatment. Washing of the carbon nanotubes is preferably carried out by the action of a non-toxic inorganic acid, such as, for example, HCl. By means of this treatment, undesirable impurities in the carbon nanotubes are removed from the production process. Functionalization of the carbon nanotubes is preferably, without implying any limitation, oxygen functionalization, in particular by the incorporation of acidic groups. This can be carried out, for example, by the action of liquid oxidizing agents or mixtures thereof and also gaseous oxidizing agents. Preference is given, for example, to HNO₃, H₂SO₄, H₂O₂, HClO₄, O₂, O₃, CO₂, etc., particularly preferably HNO₃ or mixtures of HNO₃ with H₂SO₄. The number of acidic groups can be determined by titration and/or by X-ray photoelectron spectroscopy (XPS), as described, for example, in M. Toebes, Carbon, (42), 2004, 307-315, and is usually in the range from 50 to 10,000 microequivalents/g (μeq/g) carbon nanotubes, preferably in the range from 100 to 8000 μeq/g carbon nanotubes and most preferably in the range from 250 to 5000 μeq/g carbon nanotubes.

For the coordinative polymerization of olefins, the conventional polymerization transition metal catalysts and Ziegler-Natta catalysts known to persons skilled in the art are suitable. An overview of a group of metallocene catalysts according to the prior art is given by Kaminsky et al., Appl. Cat. A.: Gen., 2002, 2001, 47-61. Examples of typical catalysts that are suitable include, without implying any limitation, the following transition metal catalysts:

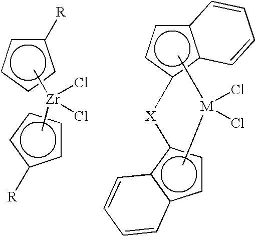

wherein R=H, methyl, ethyl, butyl, neomenthyl, etc.
wherein M=Zr, Hf and X=C₂H₄, Me₂Si, etc.

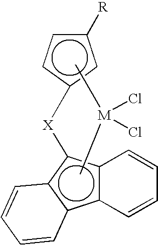

wherein M=Zr, Hf, X=Me₂C, Ph₂C, R=H, ethyl, butyl, etc.

Also suitable for the gas-phase polymerization of olefins according to the present invention are late transition metal catalysts, as described, for example, in Journal of the American Chemical Society (1995), 117 (23), 6414-15, having the following structure:
wherein M=Ni, Pd, Co, Fe, L=methyl, ethyl, butyl, R=methyl, aryl, bridged, etc.

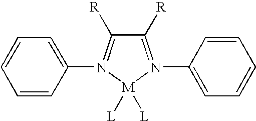

In a particular form of the method, at least one co-catalyst is also used in addition to the polymerization catalyst.

Methylalumoxane (MAO) is usually used as the co-catalyst for the above-mentioned catalysts. In principle, however, other aluminium compounds (Al compounds) are also suitable as co-catalyst, in particular aluminiumalkyls such as, for example, trimethylaluminium, triisobutylaluminium, which can optionally be activated by in situ partial hydrolysis. In the gas-phase polymerizations according to the present invention, an excess of co-catalyst is usually established as compared with the catalyst. In particular, a molar ratio co-catalyst/catalyst, in particular Al compounds/metal, of from 10 to 500, preferably from 10 to 400 and most preferably from 10 to 300, is usually established.

For the gas-phase polymerization and copolymerization of diolefins such as, for example, butadiene, isoprene, chloroprene, Ziegler-Natta catalysts based on Ni, Co, Ti and Nd are usually used. Catalysts based on Nd are preferred, because they allow polymers having a high cis content of the remaining double bonds. Without implying any limitation, the following neodymium compounds can usually be used:
Nd-versatate (versatate commercial mixture of α,α-disubstituted C₁₋₁₀-carboxylic acids), Nd-neodecanoate, [Nd(C₃H₅)₃]₂, Nd(C₃H₅)₃, Ndcp(C₃H₅)₂, Nd(C₃H₅)₃.

Diisobutylaluminium hydride (DIBAH), triisobutylaluminium and ethylaluminium sesquichloride (EASC), for example, are used as co-catalysts in such systems.

In a particular form of the method according to the present invention, at least one co-catalyst is likewise supported on the carbon nanotubes.

The preparation of the catalyst system supported on carbon nanotubes is usually started by reaction of the carbon nanotube support with the co-catalysts (in particular Al compounds). Fixing of the co-catalysts (in particular Al compounds) to the carbon nanotubes is thereby achieved. For example, this reaction can take place in solution, preference being given to the use of dry, non-polar solvents such as, for example, toluene, benzene, heptane, hexane or cyclohexane or mixtures thereof. The reaction is usually carried out in a reaction apparatus that ensures intensive mixing of the solution and of the carbon nanotubes, which can usually be in dispersed form or even in the form of agglomerates. Mixing can be carried out by means of stirrers or by means of dispersion with nozzles or jets. Alternatively, the mixing energy can be introduced in any desired form, such as, for example, ultrasound. This reaction can be carried out at room temperature or at elevated temperatures. The reaction is carried out preferably at temperatures of from 10 to 100° C. and most preferably at temperatures of from 20 to 60° C. If this reaction is complete, fixing of the polymerization catalyst to the co-catalysts (in particular Al compounds) fixed to the carbon nanotube surface is carried out by adding the catalyst in solution in a dry solvent, for example, toluene, benzene, heptane, hexane or cyclohexane, to the carbon nanotube/co-catalyst suspension. Preparation of the Supported Catalyst is then Completed by Separating Off the Solvent, for example, by evaporation. As product there is obtained an active gas-phase polymerization catalyst supported on carbon nanotubes. The co-catalyst content, based on the total weight of the suspension, is usually from 0.01 to 15 wt. %, preferably from 0.05 to 12 wt. % and most preferably from 0.1 to 10 wt. %. The catalyst content is in the range from 0.001 to 5 wt. % and preferably in the range from 0.005 to 3 wt. %, again, based on the total weight of the suspension.

The polymerization is started by addition of the gaseous monomers. Suitable monomers are any olefins and diolefins that are in gaseous form at the reaction temperature and pressure. Ethylene, propylene, butene, butadiene, isoprene, norbornene, etc. and mixtures thereof can usually be used.

The gas-phase polymerization can be carried out in any reactor suitable for gas-phase polymerization. For example, fluidized-bed reactors, stirred-vessel reactors, fixed-bed reactors, etc. are suitable.

The polymerization temperature is determined fundamentally by the kinetics of the polymerization and is limited only by apparatus-related conditions (heat transfer) and the melting point of the polymers. The polymerization temperature is usually in the range from 0 to 300° C., preferably in the range from 20 to 200° C. The gas-phase polymerization is carried out at as high a pressure as possible, because high partial pressures of olefines lead to high productivities. The reaction pressure is given by the vapor pressure of the monomers that is established at the corresponding reaction temperature. For example, without implying any limitation, the in situ polymerization of ethylene is carried out at a reaction pressure of from 1 bar to 200 bar, preferably from 1 to 100 bar. The conversion of the monomer from the gas phase can take place discontinuously, i.e. the reaction pressure in the reactor falls in the course of the reaction. Another reaction procedure is achieved by constantly metering in further monomer. The in situ polymerization is thereby carried out at a constant reaction pressure. The method according to the present invention is usually carried out in a reactor with thorough mixing of the reaction material, for example, in a stirred vessel with rotating stirrers.

The percentage of polymer (in particular polyethylene) in the carbon nanotube/polymer mixture or carbon nanotube/rubber mixture can vary according to the reaction time and reaction pressure.

### BRIEF DESCRIPTION OF THE DRAWINGS

The invention will now be described in greater detail with reference to the drawings, wherein:

FIG. 1 shows a TEM image of a carbon nanotube/polyethylene mixture;

FIG. 2 shows the structure of the extruder used in Example 5 herein below to produce the carbon nanotube/polyethylene/HDPE composite, without implying any limitation; and

FIG. 3 shows sections of two granules produced according to the inventive method.

Surprisingly, the reaction according to the present invention of the monomers on specific carbon nanotube-supported catalysts advantageously leads very successfully to only homogeneously distributed carbon nanotube/polymer mixtures or carbon nanotube/rubber mixtures being obtained. These polymer or rubber mixtures most preferably have carbon nanotube contents of from 0.1 to 50 wt. %, particularly preferably from 0.1 to 30 wt. %, based on the total weight of the mixtures. Such carbon nanotube/polymer mixtures or carbon nanotube/rubber mixtures can be processed further directly, but they can preferably also be used as a master batch, that is to say as a concentrated polymer or rubber filler mixture which is subsequently blended with a second polymer. Such carbon nanotube/polymer or carbon nanotube/rubber master batches can be mixed in an outstanding manner with other polymers, such as, for example, polyethylene, polypropylene, polyethylene-co-styrene, polybutadiene, polyisoprene, polystyrene-co-acrylonitrile, EPDM polychloroprene, polyethylene-vinyl acetate, by conventional methods, for example, solution mixing, melt mixing with extruders, etc., to give carbon nanotube/polymer composites or carbon nanotube/rubber composites.

By means of the described method steps it is possible to separate the carbon nanotubes from one another, even if they are originally in the form of bundles or agglomerates, and distribute them homogeneously in the polymer.

The success of the dispersion is usually determined by means of transmission electron microscopy (TEM) (e.g. Philips/Fei Tecnai 20 with LaB6 cathode, 1x1k CCD camera from TVIPS “F 114T, in accordance with the manufacturer's instructions) or alternatively by means of confocal laser scanning microscopy (CLSM) with fluorescence contrast (e.g. Leica TCS SP2 confocal laser scanning microscope, in accordance with the manufacturer's instructions). The presence or absence of black particles is visible by both methods, the absence of black particles meaning that the carbon nanotubes are completely dispersed and no undispersed particles are present. Depending on the content of carbon nanotubes or polymer, in particular polyethylene, carbon nanotube/polymer mixtures or carbon nanotube/polymer composites having melting temperatures in the range from 100 to 180° C., preferably from 120 to 150° C., and/or a crystallinity of from 1 to 50%, preferably from 5 to 40%, can be produced.

The invention will now be described in greater detail with reference to the following non-limiting examples.

### EXAMPLES

### Example 1

### Washing of the Carbon Nanotubes

50 g of carbon nanotubes (Baytubes, produced as described in WO 2006050903) and 1300 ml of 37% HCl were placed in a flask equipped with a stirring member and a cooler. Boiling was then carried out for one hour under reflux. After cooling, the mixture was washed with H₂O until neutral and dried overnight in vacuo at 80° C. The yield of washed carbon nanotubes was 98.7%.

### Example 2

### Functionalization of the Carbon Nanotubes

30 g of CNTs and 900 ml of 70% HNO₃ were placed in a flask equipped with a stirring member and a cooler. Boiling was then carried out for 5 hours under reflux. After cooling, the mixture was washed with H₂O until neutral and dried overnight in vacuo. The yield of functionalized carbon nanotubes was 23.37 g (77.9%). The number of acidic groups was determined by means of titration and is 931 μeq/g COOH/g carbon nanotubes.

### Example 3

### Preparation of the Catalyst

45 g of carbon nanotubes from Example 1 were placed in a reactor, which had been rendered inert and was equipped with a stirrer, an inert gas feed, a gas bubble counter, a distillation bridge and a unit for metering liquids under protecting gas. Any traces of O₂ or H₂O present were then removed by intensive flushing for one hour with argon at 120° C. (oil bath). After cooling to room temperature, 30.7 g of MAO in toluene and 116 mg of (n-Bu-cp)₂ZrCl₂ (Bu=butyl, cp=cyclopentadienyl) were fed into the reactor via a polyethylene hose connection for the closed addition of “dried” solvents/chemicals which had previously been flushed intensively with inert gas. The carbon nanotube/catalyst suspension was stirred intensively for about 5 hours, and then the solvent was removed by distillation.

### Example 4

### In Situ Gas-Phase Polymerization of Ethylene

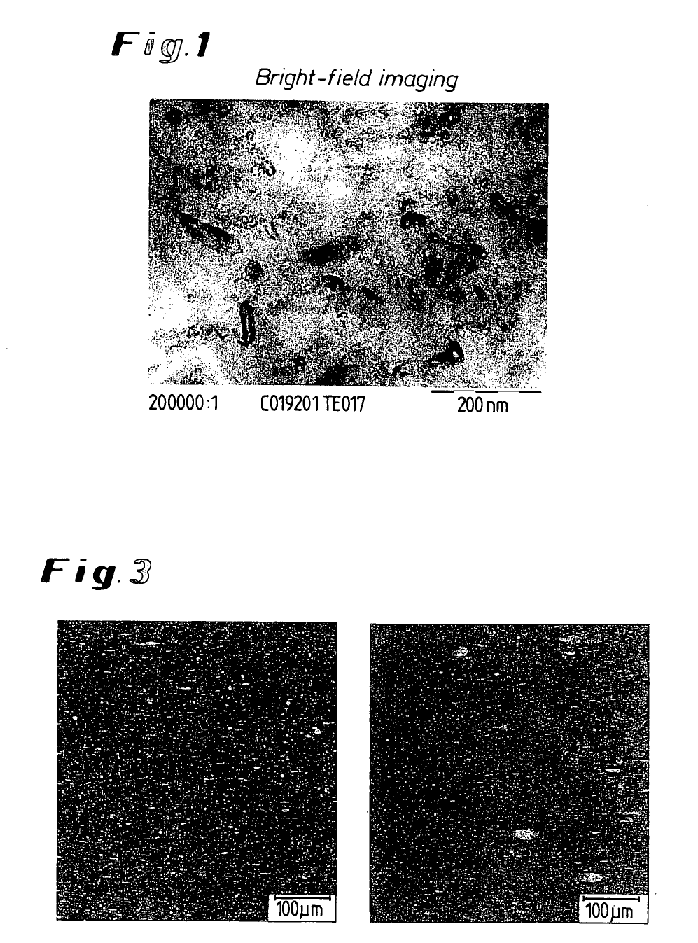

45 g of the catalyst prepared in Example 3 were introduced into a pressure-resistant steel autoclave equipped with a low-speed (300 rpm) anchor stirrer, and heated to a reaction temperature of 90° C. The gas-phase polymerization was then started by adjusting to 10 bar ethylene. The polymerization was carried out at constant pressure, because automatic addition of the consumed ethylene was carried out via the installation's own control system. After the metered addition of 325 liters of ethylene (372 g of ethylene), the polymerization was terminated by cooling. 324 g of a carbon nanotube/polyethylene mixture were obtained, which corresponded to a content of 13.9 wt. % carbon nanotubes, based on polyethylene. The success of the dispersion was determined by means of transmission electron microscopy and is shown in FIG. 1. A melting temperature of 129.5° C. was determined by means of differential scanning calorimetry (e.g. Mettler Toledo DSC 822^{e}, in accordance with the manufacturer's instructions). The crystallinity of the sample was calculated in the manner described, for example, in Macromol. Chem. 2001, (202), 2239-2246 and was 39%.

### Example 5

### Production of a Carbon Nanotube/Polymer Composite from a Carbon Nanotube/Polyethylene Master Batch Polymerized In Situ and High Density Polyethylene (HDPE)

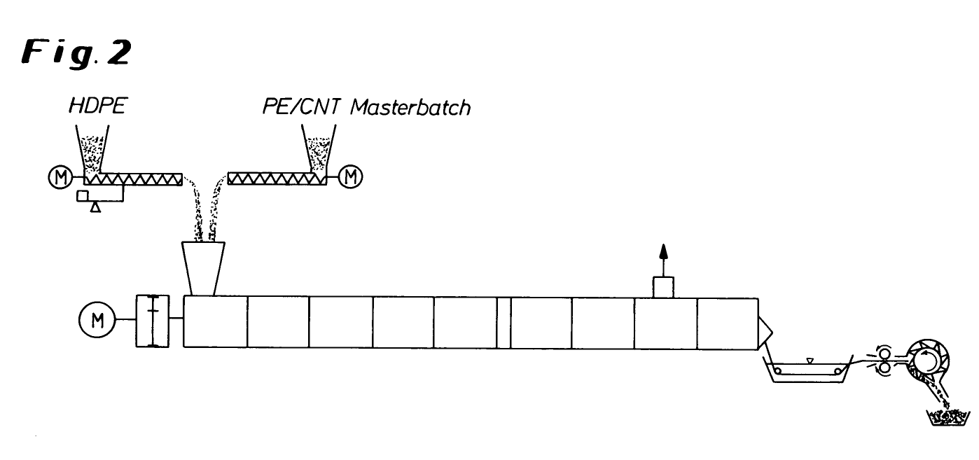

A carbon nanotube/polyethylene master batch polymerized in situ and having a content of 13 wt. % carbon nanotubes was incorporated into a HDPE (Lupolen 4261, Basell) in a co-rotating twin-screw extruder. Both the HDPE and the carbon nanotube/polyethylene master batch were in powder form. 8 wt. % master batch and 92 wt. % HDPE were each fed via a proportioning weigher into the main intake of the extruder, so that the carbon nanotube concentration in the end product was 1 wt. %. The extruder used was a ZSK 26Mc from Coperion Werner & Pfleiderer having a length/diameter ratio of 36 (see FIG. 2). The total throughput was 16 kg/h at a speed of 250 min⁻¹. In the extruder, melting of the HDPE and of the polyethylene master batch and distributive and dispersive mixing of the carbon nanotubes into the molten HDPE took place. Moisture was removed in the penultimate barrel by aeration. Four extrudates were formed in a perforated die and were then cooled in a water bath and granulated by means of a strand pelletiser.

The dispersion quality of the carbon nanotubes in the end product was determined by means of confocal laser scanning microscopy (CLSM) with fluorescence contrast (Leica TCS SP2 confocal laser scanning microscope (CLSM)). In CLSM images, carbon nanotube agglomerates appear as black particles because they do not fluoresce. FIG. 3 shows sections of two granules. No black particles are to be seen, which means that the carbon nanotubes are completely dispersed and no undispersed particles are present. It should be understood that the preceding is merely a detailed description of one preferred embodiment or a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

What is claimed is:

1. A method for producing carbon nanotube/polymer mixtures or carbon nanotube/rubber mixtures comprising in situ gas-phase polymerizing of olefins or diolefins in the presence of polymerization catalysts supported on the carbon nanotubes.

2. Method according to claim 1, wherein the carbon nanotubes have been physically or chemically treated.

3. Method according to claim 1, wherein the carbon nanotubes have a content of acidic groups of from 50 to 10,000 meq/g carbon nanotubes.

4. Method according to claim 1, wherein said polymerizing is conducted in the presence of at least one co-catalyst.

5. Method according to claim 4, wherein an excess of co-catalyst is established as compared with the catalyst.

6. Method according to claim 5, wherein the excess is a molar ratio co-catalyst/catalyst of from 10 to 500.

7. Method according to claim 4, wherein at least one co-catalyst is supported on the carbon nanotubes.

8. Method according to claim 4, wherein the co-catalyst content, based on the total weight of a suspension comprising the carbon nanotubes, the catalyst and the co-catalyst, is from 0.01 to 15 wt. %.

9. Method according to claim 1, wherein the gas-phase polymerization is carried out at a temperature in the range from 0 to 300° C.

10. Carbon nanotube/polymer mixture or carbon nanotube/rubber mixture obtainable by the method according to claim 1.

11. Carbon nanotube/polymer mixture or carbon nanotube/rubber mixture according to claim 10, which has a carbon nanotube content of from 0.1 to 50 wt. % based on the total weight of the mixture.

12. Carbon nanotube/polymer mixture or carbon nanotube/rubber mixture according to claim 10, wherein the carbon nanotubes are distributed in the polymer or rubber homogeneously.

13. Carbon nanotube/polymer mixture or carbon nanotube/rubber mixture according to claim 10, which exhibits a melting temperature in the range from 100 to 180° C. and/or a crystallinity of from 1 to 50%.

14. Carbon nanotube/polymer mixture or carbon nanotube/rubber mixture according to claim 13, which exhibits a crystallinity of from 5 to 40%.

15. A method for producing carbon nanotube/polymer composites or carbon nanotube/rubber composites comprising mixing the carbon nanotube/polymer mixture or carbon nanotube/rubber mixture according to claim 10 in a polymer.

16. Carbon nanotube/polymer composite or carbon nanotube/rubber composite obtainable by the method according to claim 15.

17. Carbon nanotube/polymer composite or carbon nanotube/rubber composite according to claim 16, wherein the carbon nanotubes are distributed in the composite homogeneously.

18. Carbon nanotube/polymer composite or carbon nanotube/rubber composite according to claim 16, which exhibits a melting temperature in the range from 100 to 180° C. and/or a crystallinity of from 1 to 50%.

19. Carbon nanotube/polymer composite or carbon nanotube/rubber composite according to claim 18, which exhibits a crystallinity of from 5 to 40%.
